(19) United States
(12) Patent Application Publication
(10) Pub. No.: US 2025/0058863 A1
(43) Pub. Date: Feb. 20, 2025

(54) WIND PROPULSION UNIT AND VESSEL COMPRISING SUCH A UNIT

(71) Applicant: AYRO, Paris (FR)

(72) Inventors: Nicolas SDEZ, Paris (FR); Ludovic GERARD, Marseille (FR)

(21) Appl. No.: 18/722,772

(22) PCT Filed: Dec. 23, 2022
(86) PCT No.: PCT/IB2022/062734

§ 371 Date: Jun. 21, 2024

(30) Foreign Application Priority Data
Dec. 23, 2021 (FR) 2114460

(51) Int. Cl. B63H 9/061

(52) U.S. Cl. CPC B63H 9/0635

(57) ABSTRACT

A wind propulsion unit including a dual wingsail mounted on a structure that is angularly controlled about a generally vertical axis depending on the conditions, the dual wingsail including a front flap, a rear flap and a supporting structure that allows the front flap and the rear flap to pivot about two axes that are generally parallel and spaced apart from one another, the unit also including a device for controlling the orientation of the rear flap according to the direction of incidence of the wind during propulsion. The device for controlling the orientation of the rear flap is also configured to bring the rear flap, when the wind propulsion unit is in an inactive position, into a folded orientation wherein a substantial portion of its cross-sectional extent is positioned along a substantial portion of the cross-sectional extent of the front flap.

### FIELD OF THE INVENTION

The present invention relates generally to wind propulsion, and more particularly to a new type of propulsion wingsail for cruisers and workboats.

### PRIOR ART

In particular, documents WO2018087649A1 and WO2020115717A1 describe a wind propulsion device comprising a double sail mounted on a structure angularly controlled about a generally vertical axis according to conditions, the double sail comprising a front flap and a rear flap, a front mast and a rear mast connected by an element forming a boom and by an element forming a gaff, the front flap being traversed by the front mast and turning on an axis defined thereby, and the rear flap being traversed by the rear mast and turning on an axis defined thereby. Said structure is capable of turning on an axis of rotation located on the front mast.

US2018162502A1 also describes a submersible craft with a dual wingsail that can be tilted to limit drag during submerged travel. The wingsail also incorporates a complex mechanism for shifting the rear flap laterally to position it alongside the front flap.

Finally, GB2590082A describes a three-flap wingsail wherein the rear flap can adopt an orientation opposite to that of the other two flaps. In this position, however, the wingsail still has a substantial footprint.

### SUMMARY OF THE INVENTION

The aim of the present invention is to provide a particularly simple and effective solution for selectively limiting, when not in use, the size of a device comprising two flaps with variable orientation.

For this purpose, a dual wingsail propulsion unit is proposed comprising a dual wingsail mounted on a structure that is angularly controlled about a generally vertical axis depending on the conditions, the dual wingsail comprising a front flap, a rear flap and a supporting structure that allows the front flap and the rear flap to pivot about two axes that are generally parallel and spaced apart from one another, the unit also comprising a device for controlling the orientation of the rear flap according to the direction of incidence of the wind during propulsion, the device for controlling the orientation of the rear flap also being configured to bring the rear flap, when the wingsail propulsion unit is in an inactive position, into a folded orientation wherein a substantial portion of its cross-sectional extent is positioned along a substantial portion of the cross-sectional extent of the front flap.

The wind propulsion unit optionally comprises the following additional features, taken individually or in any combination that a person skilled in the art will understand as being technically compatible with one another:
the front flap is devoid of an orientation control device and, in use, is free to move within a certain angular range, and as it approaches its folded position, the rear flap is capable of urging and angularly shifting the front flap so as to minimize the flaps footprint in the direction of their thickness.
the angular offset of the front flap is such that the axes of their cross-sectional profiles are generally parallel in the folded position.
the axes of the flap profiles in cross-section, in the folded position, are angularly offset by approximately 2 to 20° from a plane containing the axes of both masts.
in the folded position, a trailing edge of the rear flap is close to a leading edge of the front flap.
the supporting structure comprises at least one boom element and/or gaff element, and in that in the folded position and in cross-section, the front and rear flaps are entirely inscribed in the contour of the boom element and/or gaff element.
the unit also comprises means for locking the rear flap in its folded position.

A vessel is also proposed, characterized in that it comprises at least one wind propulsion unit as defined above.

In a particular embodiment, the vessel comprises a mechanism for bringing the or each wind propulsion unit from an active position to an inactive position, the folding control device being controlled in relation to the control of said mechanism.

Said inactive position can be, in particular, a stowed or retracted position.

### BRIEF DESCRIPTION OF THE DRAWINGS

Other aspects, aims, and advantages of the present invention will become more apparent on reading the following detailed description of a preferred embodiment thereof, given by way of non-limiting example and made with reference to the accompanying drawings, wherein:

FIG. 1 is an overall perspective view of a wind propulsion system according to one embodiment of the invention, in an operating position,

FIG. 2 is a schematic horizontal sectional view of the device shown in FIG. 1, in the same position as in FIG. 1,

FIG. 3 is an overall perspective view of the device shown in FIGS. 1 and 2, in a non-operating position,

FIG. 4 is a schematic horizontal sectional view of the device shown in the preceding figures, in the same position as in FIG. 3,

FIG. 5 is a perspective view of a particular embodiment of a wind propulsion system according to the invention,

FIG. 6 is a perspective view showing the device of FIG. 5 in a lowered state, and

FIG. 7 is a perspective view showing the device of FIG. 6 in a folded state.

### DETAILED DESCRIPTION OF A PREFERRED EMBODIMENT

With reference to the figures, a wind propulsion system according to the invention takes the form of a wingsail comprising two aerodynamic airfoils, both of which are adjustable in terms of incidence and relative pitch angle. In the following, we refer to them as the first or front flap, and the second or rear flap. They are designated by references 100 and 200, respectively. They pivot on axes defined by two respective masts 310, 320, in this case cylindrical, as will be seen below.

At least one of these airfoils has an asymmetrical aerodynamic cross-section in the front-to-rear direction (with leading edge and trailing edge). These can be symmetrical wingsail sections, for example, and more preferably NACA 00xx standard sections or others.

The relative angle of the second flap to the first flap is adjustable, possibly differentially depending on height, to allow the second flap to twist.

Details of the operation and wind behavior of such a device can be found in document WO2020115717A1.

The device further comprises a rigid frame 300 formed by the two cylindrical masts 310, 320, here of constant external diameter, and by generally horizontal structural elements, 330, 340, respectively lower and upper, forming respectively a boom element and a gaff element. This structural frame is free to rotate about a vertical axis A1 formed by the front mast 310. The elements of this structural frame are made up of metal or composite parts, for example, which are suitably dimensioned for the stresses involved.

In the present example, as the thickness of the rear flap 200 is smaller than that of the front flap 100, the rear mast 320 may have a smaller diameter than that of the front mast 310. It marks the axis A2 on which the rear flap 200 pivots relative to the structure 300.

The structure 300 as a whole can be pivoted relative to the vessel, using an appropriate control, by being carried by a pivot 500 mounted on the vessel's deck, the pivoting axis of the structure as a whole advantageously coinciding with the axis A1 defined by the front mast 310.

The means of controlling the orientation of the front and rear flaps around their respective masts may be of the type described in WO2020115717A1, other means being of course possible.

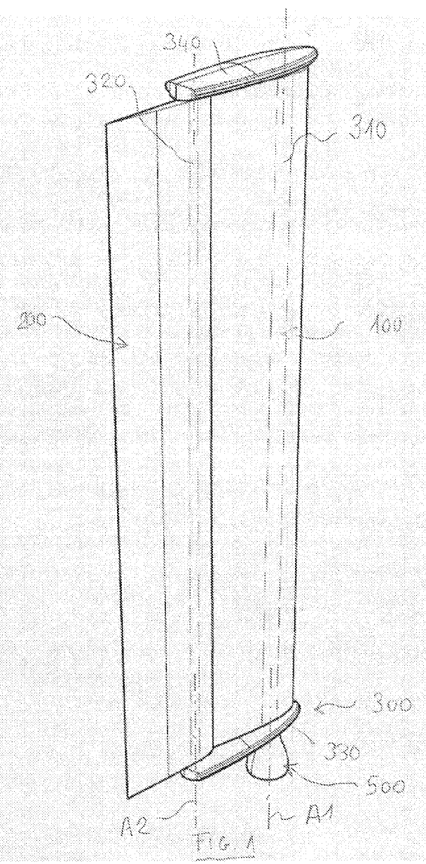

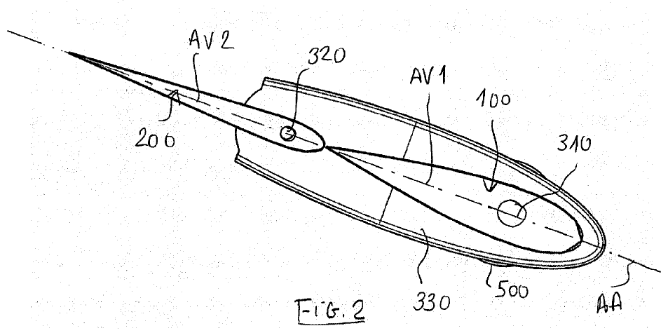

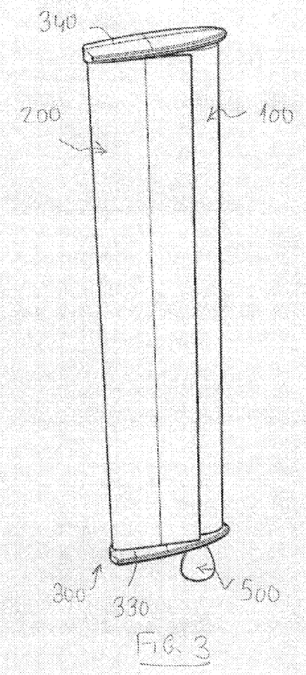

According to one aspect of the invention, the device can assume the operating position as shown in FIGS. 1 and 2, with the degrees of freedom of the flaps in turning and, if applicable, in twisting as described in WO2020115717A1, it being noted that the position shown in FIGS. 1 and 2 is the one where the two flaps are in the median position.

Where space or footprint is to be reduced, the device is designed to allow the rear flap 200 to be folded forward about its pivot axis A2, through an angle on the order of 180°, so that it lies alongside the front flap.

This arrangement reduces the device's fore-to-aft footprint, for example:
to limit its exposure to the wind in the event of a storm,
to facilitate its stowage when it needs to be retracted, whether by tilting, by translation along one of the main axes (longitudinal, transverse and vertical) of the vessel, or by any combination of movements,
to limit its form factor, for example during loading and unloading maneuvers when the device is mounted on a merchant marine vessel,
or during the manufacturing, transport or handling phases of the device.

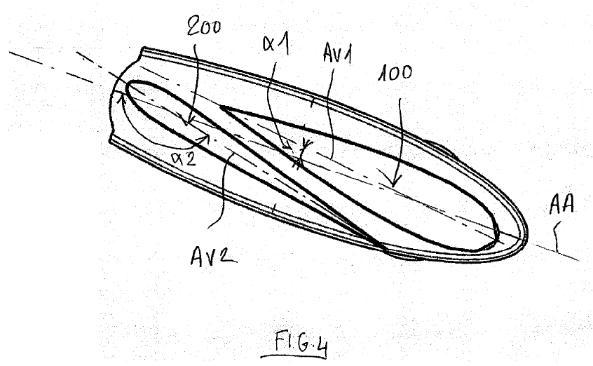

The folding movement of the rear flap is advantageously accompanied, as can be seen clearly in FIG. 4, by a slight angular displacement of the front flap 100 by an angle α1 through rotation about its axis A1, relative to the plane of the supporting structure 300, as depicted in FIG. 4 by its longitudinal axis AA. This allows the rear flap 200 to be folded down without the rear edge 110 of the front flap interfering with this movement. Advantageously, the angular offset of the front flap is such that the axes AV1, AV2 of the front and rear flap profiles in cross-section are generally parallel.

In the first case, the front flap is passive, i.e. has no specific actuator, and when in operation, moves freely within a certain angular range as it is blown by the wind. In this case, the rear flap, as it folds, slightly stresses the front flap, shifting it angularly, thus bringing the axes AV1 and AV2 of the two flap profiles into a parallel or slightly inclined relationship. In this case, the gap between the two flaps shown in FIG. 4 does not exist. The load can be applied, for example, directly to the entire flap surface, or to internal flap shape elements, or to dedicated, localized support elements.

In a second case, the front flap is fitted with an orientation change device, which is operated to bring the axis AV1 of the front flap profile into a parallel or slightly inclined position relative to the axis AV2 of the rear flap profile.

Equally advantageously, at the end of folding, the cross-sections of the front and rear flaps are fully inscribed in the contours of the boom element, and preferably also of the gaff element.

More precisely, with conventional wingsail profiles, the angle α1 formed by the axis AV1 of the front flap in relation to the longitudinal axis AA of the structure 300 in this position is advantageously about 2 to 20°, while the angle α2 formed by the axis AV2 of the rear flap in relation to the said longitudinal axis AA is advantageously about 160 to 178°, these values depending essentially on the type of profile (in particular length/thickness ratio) of each of the flaps.

The rear flap is folded (and the front flap angled if it is not free) either manually or by motor. In the case of motorized control, an end-of-stroke control arrangement can be provided based on any type of servo drive, in particular mechanical, optical, electrical or electromagnetic, or with a stepper motor for fine control of the angular position at the end of folding. In particular, the orientation control mechanisms described in document WO2020115717A1 can be used, with the person skilled in the art being able to make the necessary adaptations.

It is also possible to mechanically lock the two flaps in the folded position, either to each other or to the frame 300. The locking means may comprise, for example, locking fingers cooperating with associated arrangements provided on or in the boom element 330 or gaff element 340 and actuated mechanically, by electromagnets, etc.

Now with reference to FIGS. 5 to 7, we have shown a wind protection device where the front flap and the flap can be lowered, for example as described in document WO2020115717A1.

The two flaps are here defined respectively by a series of front shape elements 120 and a series (preferably of the same number) of rear shape elements 220 which together describe an envelope of symmetrical aerodynamic profiles intended to form, in cooperation with respective envelopes 110, 210, the first and second flaps 100, 200.

These shape elements are free to rotate and move in translation on their respective mast 310, 320, the translation allowing the two flaps to be hoisted and lowered and, if necessary, reefed.

In FIG. 5, the propulsion system is in its operating state, with the tilting of the front and rear flaps controlled according to navigation conditions.

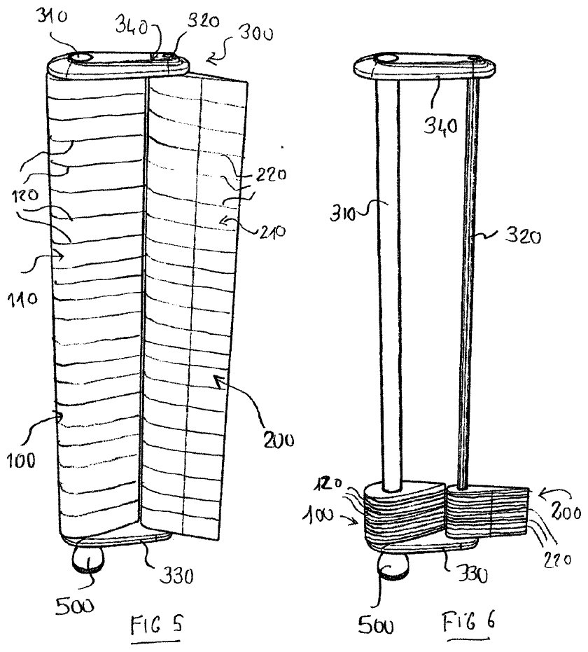

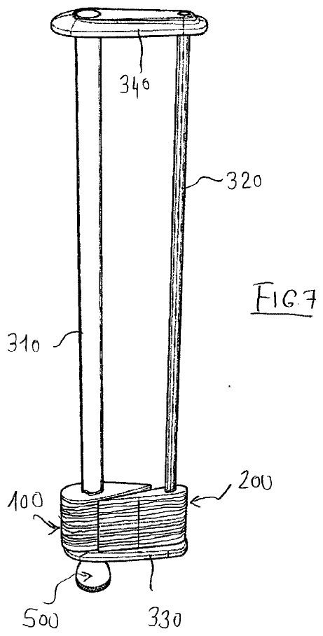

In FIG. 6, both flaps have been lowered, and take up limited space along the boom element 330.

Finally, in FIG. 7, the rear flap has been folded against the front flap as described above.

In particular, this lowers the device's center of gravity during travel.

Of course, the present invention is by no means limited to the embodiments described above and shown in the drawings; rather, the person skilled in the art will know how to make numerous variants or modifications.

1. A dual wingsail propulsion unit comprising a dual wingsail mounted on a structure that is angularly controlled about a generally vertical axis depending on the conditions, the dual wingsail comprising a front flap, a rear flap and a supporting structure that allows the front flap and the rear flap to pivot about two axes that are generally parallel and spaced apart from one another, the unit also comprising a device for controlling the orientation of the rear flap according to the direction of incidence of the wind during propulsion, the device for controlling the orientation of the rear flap also being configured to bring the rear flap, when the wingsail propulsion unit is in an inactive position, into a folded orientation wherein a substantial portion of its cross-sectional extent is positioned along a substantial portion of the cross-sectional extent of the front flap.

2. The unit according to claim 1, wherein the front flap is devoid of an orientation control device and, in use, is free to move within a certain angular range, and in that as it approaches its folded position, the rear flap is capable of urging and angularly shifting the front flap so as to minimize the flaps footprint in the direction of their thickness.

3. The unit according to claim 1, further comprising a device for controlling the orientation of the rear flap, capable of angularly shifting the front flap in the folded position of the rear flap, so as to minimize the flaps footprint in the direction of their thickness.

4. The unit according to claim 2, wherein the angular offset of the front flap is such that the axes of their cross-sectional profiles are generally parallel in the folded position.

5. The unit according to claims 3, wherein the axes of the profiles of the flaps in cross-section, in the folded position, are angularly offset by approximately 2 to 20° from a plane containing the axes of both masts.

6. The unit according to claim 1, wherein, in the folded position, a trailing edge of the rear flap is located in close proximity to a leading edge of the front flap.

7. The unit according to claim 1, wherein the supporting structure comprises at least one boom element and/or gaff element, and in that in the folded position and in cross-section, the front and rear flaps are entirely inscribed in the contour of the boom element and/or gaff element.

8. The unit according to claim 1, further comprising a lock for locking the rear flap in its folded position.

9. An at least partially wind-propelled vessel, comprising at least one dual wingsail propulsion unit comprising a dual wingsail mounted on a structure that is angularly controlled about a generally vertical axis depending on the conditions, the dual wingsail comprising a front flap, a rear flap and a supporting structure that allows the front flap and the rear flap to pivot about two axes that are generally parallel and spaced apart from one another, the unit also comprising a device for controlling the orientation of the rear flap according to the direction of incidence of the wind during propulsion, the device for controlling the orientation of the rear flap also being configured to bring the rear flap, when the wingsail propulsion unit is in an inactive position, into a folded orientation wherein a substantial portion of its cross-sectional extent is positioned along a substantial portion of the cross-sectional extent of the front flap.

10. The vessel according to claim 9, further comprising a mechanism for bringing the or each wind propulsion unit from an active position to an inactive position, the folding control device being controlled in relation to the control of said mechanism.

11. The vessel according to claim 10, wherein said inactive position is a stowed or retracted position.
